(19) United States
(12) Patent Application Publication
(10) Pub. No.: US 2010/0068526 A1
(43) Pub. Date: Mar. 18, 2010

(54) MATERIALS CONTAINING CARBON NANOTUBES, PROCESS FOR PRODUCING THEM AND USE OF THE MATERIALS

(76) Inventors: Horst Adams, Altstatten (CH); Michael Dvorak, Thun (CH)

Correspondence Address: BANNER & WITCOFF, LTD., TEN SOUTH WACKER DRIVE, SUITE 3000, CHICAGO, IL, 60606, US

(21) Appl. No.: 12/447,745

(22) PCT Filed: Oct. 10, 2007
(86) PCT No.: PCT/EP2007/008807

§ 371 Date: Apr. 29, 2009

(30) Foreign Application Priority Data
Oct. 31, 2006 (EP) 06405458.8

(51) Int. Cl. B21D 39/00; B22F 9/04; B29C 69/02

(52) U.S. Cl. 428/408; 75/352; 75/243; 264/241; 428/323; 977/742

(57) ABSTRACT

Material in particle or powder form containing carbon nano tubes (CNT), where in the material for example a metal is laminated in layers of a thickness of 10 nm to 500,000 nm alternating with layers of CNT in a thickness from 10 nm to 100,000 nm. The material is produced by mechanical alloying i.e. by repeated deformation, breaking and welding of metal particles and CNT particles, preferably by milling in a ball mill containing a milling chamber and milling balls as the milling bodies and a rotary body to generate high energy ball collisions.

The present invention concerns materials containing carbon nano tubes. The invention also concerns a method for production of the materials and the use of the materials for formed bodies.

Carbon nano tubes are known. Other equivalent terms for carbon nano tubes are nano-scale carbon tubes or the abbreviation CNT. The most common name used in the specialist world, namely CNT, is used below. CNT are fullerenes, and are carbon modifications with closed polyhedral structure. Known areas of application for CNT can be found in the field of semiconductors or to improve mechanical properties of conventional plastics (www.de.wikipedia.org under “carbon nano tubes”).

The object of the present invention is to expand the area of use of CNT and propose new materials and bodies formed therefrom.

According to the invention this is achieved by materials containing at least one metal and/or at least one polymer laminated in layers alternating with layers of CNT.

The material is advantageously present in granular or particle form, where the particle size amounts to 0.5 μm to 2000 μm, advantageously 1 μm to 1000 μm. The individual layers of the metal or polymer can have a thickness from 10 nm to 500,000 nm, advantageously from 20 nm to 200,000 nm. The thickness of the individual layers of CNT can range from 10 nm to 100,000 nm, advantageously 20 nm to 50,000 nm.

Suitable metals are ferrous and non-ferrous metals and precious metals. Suitable ferrous metals are iron, cobalt and nickel, their alloys, and steel. Non-ferrous metals include aluminium, magnesium and titanium etc. and their alloys. Further examples of metals may be vanadium, chromium, manganese, copper, zinc, tin, tantalum or tungsten and their alloys, or the alloys bronze and brass. Rhodium, palladium, platinum, gold and silver can also be used. The said metals can be pure or used combined in mixtures. Aluminium and its alloys are preferred. As well as pure aluminium, aluminium alloys are preferred. The metal is used granular or in granulate or powder form in the method according to the invention. Typical grain sizes of metals are from 5 μm to 1,000 μm and suitably from 15 μm to 1,000 μm.

Suitable polymers are thermoplastic, elastic or duroplastic polymers. Examples are polyolefins such as polypropylene or polyethylene, cyclo-olefin copolymers, polyamides such as polyamide 6, 12, 66, 610 or 612, polyesters such as polyethyleneterephthalate, polyacrylonitrile, polystyrene, polycarbonate, polyvinylchloride, polyvinylacetate, styrene-butadiene copolymers, acrylonitrile-butadiene copolymers, polyurethane, polyacrylate and copolymers, alkyd resins, epoxide, phenol-formaldehyde resin, urea-formaldehyde resin etc. In the method according to the invention the polymers are used pure or mixed together or in mixtures with metal, in grains or in granulate or powder form. Typical grain sizes of the polymers are from 5 μm to 1,000 μm and suitably from 15 μm to 1,000 μm.

Suitable CNTs are for example materials produced catalytically in arcs, by means of laser or by gas substitution. The CNT can be single-walled or multi-walled or two-walled. The CNT can be open or closed tubes. The CNT can have diameters from 0.4 nm (nanometre) to 50 nm and a length of 5 nm to 50,000 nm. The CNT can have sponge-like structures i.e. two- or three-dimensional skeletal bodies which constitute mutually cross-linked carbon nano tubes. The diameter of the individual tubes fluctuates in the range given above from e.g. 0.4 nm to 50 nm. The extent of the sponge structure, i.e. the side lengths of a skeletal body of CNT, can for example be given as 10 nm to 50,000 nm, advantageously 1,000 nm to 50,000 nm in each dimension.

The material according to the present invention can for example contain 0.1 to 50 w. % CNT in relation to the material. Suitable quantities are from 0.3 to 40 w. %, preferably from 0.5 to 20 w. % and in particular 1 to 10 w. % CNT in the material. If aluminium or an aluminium alloy constitutes the metal of the material, the material can suitably contain 0.5 to 20 w. % CNT in relation to the material, where 3 to 17 w. % CNT is preferred and 3 to 6 w. % CNT particularly preferred.

The materials can comprise said metals and said CNT, they can comprise said metals, polymers and CNT or can comprise said polymers and CNT, or the materials listed above can also contain additional admixtures, for example functional admixtures. Functional admixtures are for example carbon also in the form of soot, graphite and diamond modifications, glass, carbon fibres, plastic fibres, inorganic fibres, glass fibres, silicates, ceramic materials, carbides or nitrides of aluminium or silicon, such as aluminium carbide, aluminium nitride, silicon carbide or silicon nitride, for example also in fibre form known as whiskers.

The materials according to the invention can be produced by mechanical alloying of the respective proportions of metal, polymer and CNT. Mechanical alloying can be performed by repeated deformation, breaking and welding of powdery particles of the metal or polymer and the CNT. According to the invention, particularly suitable for mechanical alloying are ball mills with high energy ball collisions. A suitable energy provision is achieved for example in ball mills, the milling chamber of which has a cylindrical, preferably circular cylindrical, cross-section, and the milling chamber is usually arranged horizontally. The milling product and the milling balls are moved by the milling chamber rotating about its cylindrical axis, and are further accelerated by a driven rotary body extending in the direction of the cylindrical axis into the milling chamber and fitted with a multiplicity of cams. The speed of the milling balls is advantageously set at 4 m/s and higher, suitably at 11 m/s and higher. Advantageously the speed of the milling balls is from 11 to 14 m/s. Also advantageous is a rotary body on which the multiplicity of cams are arranged distributed over the entire length. The cams can for example extend over 1/10 to 9/10, preferably 4/10 to 8/10, of the radius of the milling chamber. Also advantageous is a rotary body which extends over the entire extension of the milling chamber in the cylindrical axis. The rotary body and the milling chamber are driven independently of each other or in synchrony and set in motion by an external drive. The milling chamber and the rotary body can run in the same direction or preferably in opposite directions. The milling chamber can be evacuated and the milling process operated in a vacuum, or the milling chamber can be filled with a protective or inert gas. Examples of protective gases are e.g. N₂, CO₂, and examples of inert gases are He or Ar. The milling chamber and hence the milled product can be heated or cooled. In some cases milling can be performed cryogenically.

A typical milling duration is 10 hours or less. The minimum milling duration is suitably 15 minutes. A preferred milling duration is between 15 minutes and 5 hours. Particularly preferably the milling duration is from 30 minutes to 3 hours, in particular up to 2 hours.

The ball collisions are the main basis for the energy transfer. The energy transfer can be expressed by the formula Eₖᵢₙ=mv², where m is the mass of the balls and v the relative speed of the balls. The mechanical alloying in the ball mill is usually performed with steel balls for example with a diameter of 2.5 mm and a weight of around 50 g, or with zirconium oxide balls (ZrO₂) of the same diameter and a weight of 0.4 g.

Corresponding to the energy provision to the ball mill, materials are produced with preferred distribution of layers of metal and polymer and CNT. As more energy is supplied, the thickness of the individual layers can be changed. As well as energy provision, the thickness of the CNT structure which is supplied to the milling process can control the thickness of the CNT layers in the milled material. With increasing energy provision, the thickness of the individual layers can be reduced and the respective layer expanded in relation to its surface area. With the increasing expansion in area for example, individual layers of CNT can touch, forming complete CNT layers in two dimensions or CNT layers extending in two dimensions which touch through a particle. Thus, firstly the excellent properties of CNT, for example thermal conductivity and electrical conductivity, and secondly the ductility of the metal or elasticity of the polymer, are substantially retained in the material in the invention.

A further control of properties of the material according to the invention can be achieved by mixing two or more materials from different starting substances and/or with different levels of energy provision during production. Also, substances such as metal or plastic free from CNT, and one or more materials containing CNT, can be mixed or mechanically alloyed i.e. ground. The different materials, where applicable with the substances, can be mixed or subjected to a second grinding or several grindings. The second grinding or successive grindings can for example have a milling duration of 10 hours or less. The minimum time for the second grinding is suitably 5 minutes. A second grinding duration between 10 minutes and 5 hours is preferred. Particularly preferred is a second milling duration from 15 minutes to 3 hours, in particular up to 2 hours.

For example a material according to the invention with high CNT content and a material of lower CNT content, or materials with different levels of energy provision, can be processed in a second milling process. Also, a material containing one CNT, such as a CNT-containing metal e.g. aluminium, can be processed with a CNT-free metal e.g. also aluminium, in a second milling process. The second milling process or several milling processes, or mechanical alloying, are continued only insofar as the resulting material is not completely homogenised, but the properties inherent to each material or substance are retained and the effects are complementary in the final material.

With the method described, the properties inherent to CNT which in themselves make targeted processing impossible, such as a low specific weight in relation to the specific weight of metals, and the poor cross-linkability of CNT through metals, can be overcome. Thus, for example for the different densities, for aluminium 2.7 g/cm³ and for CNT 1.3 g/cm³ can be given.

The materials according to the invention are used for example in formed bodies including semi-finished products, and layers which are produced by spray compacting, thermal spray methods, plasma spraying, extrusion methods, sintering methods, pressure-controlled infiltration methods or pressure casting.

The present materials according to the invention can consequently be processed into formed bodies, for example by spray compacting. In spray compacting, a metal melt, a melt for example of a steel, magnesium or preferably aluminium or an aluminium alloy, is passed over a heated crucible to a spray head, there atomised into fine droplets and sprayed onto a substrate or base. The droplets, initially still as melt liquid, cool during the flight from the atomisation device to the substrate which is located below. The particle stream makes contact there at high speed to grow into a so-called deposit, harden thoroughly and cool further. In spray compacting, for the forming process use is made of the special phase transition “liquid to solid”, which is difficult to define precisely as a state, of small melt particles which grow together into a closed material compound. In the present case, the material according to the invention containing CNT is supplied to the atomisation device in powder form and fine metal droplets are sprayed from the atomisation process of the metal melt. The process control is such that the materials containing CNT are not melted or only melted on the surface and there is no de-mixing. The particle stream of material and metal droplets hits the substrate with high speed and grows into a deposit. Depending on the substrate, such as turntable, rotating rod or plate, as a formed body, solid bodies are produced such as bolts, hollow bodies such as tubes, or material strips such as sheets or profiles. The deposit is an intimate and homogenous mixture of metal with embedded CNT with the desired even arrangement of constituents in the structure. For example, the deposit can take the form of a bolt. In subsequent treatment steps such as extrusion of a bolt, highly compact and fault-free semi-finished products (tubes, sheets etc.) or formed bodies with a lamellar structure can be generated. The semi-finished products and formed bodies have e.g. a structural anisotropy of varying extent, and mechanical and physical properties such as electrical conductivity, thermal conductivity, strength and ductility. Further applications of the materials according to the invention lie in the range of neutron-absorbing curtains, radiation moderation or the generation of layers for radiation protection.

The present materials can be used otherwise as formed bodies or layers, where the formed bodies are produced by thermal spray methods such as plasma spraying or cold gas spraying. In thermal spray methods, powdery materials are injected into an energy source and there, depending on process variant, only heated, melted or fully melted and accelerated at high speed (depending on method and choice of parameters, from a few m/s up to 1500 m/s) in the direction of the surface to be coated, where the particles occurring are deposited as a layer. If the particles which are ideally heated or only melted on the surface, hit the substrate with a very high kinetic energy, the CNT lie preferably in the droplet plane i.e. transverse to the direction of irradiation and impact. This leads to a controlled anisotropy of material properties such as tensile strength.

The CNT-containing materials forming the basis of this invention can also be processed into formed bodies by extrusion methods, sintering methods or diecasting methods. In pressure or diecasting, a slow, in particular laminar, continuous mould filling is desired with high metal pressures. For example composite materials can be produced by infiltration of porous fibre or particle formed bodies by a liquefied metal.

In the present pressure or diecasting method, suitably the material according to the invention is presented, from which the metal containing CNT is supplied to a casting mould as a powdery matrix material. A metal with melting point lying below that of the material, for example for aluminium-containing materials a metal with a melting temperature below 750° C., is pressed slowly into the heated casting mould. The liquid metal penetrates the powdery matrix material under the applied pressure. The casting mould is then cooled and the formed body removed from the mould. The method can also be performed continuously. In one embodiment variant the metal e.g. aluminium is processed into preproducts with thixotropic behaviour and the CNT incorporated. Instead of liquefied metals, a preheated metal which is thixotropic in state (part liquid, part solid), containing the CNT, is pressed into the casting mould. It is also possible to place the material in particle or granulate form, where in the individual particles the metal is arranged in layers alternating with layers of CNT, as bulk product in the casting mould, heat the casting mould and under pressure achieve a complete mould filling without pores or pinholes in the resulting formed body. Finally, roughly mixed metal powder e.g. aluminium powder or aluminium with thixotropic properties and CNT, the CNT in sponge form or as clusters with a diameter of for example up to 0.5 mm, can be roughly mixed and pressed into the casting mould under the effect of heat to melt the metal. Favourable formed bodies, for example rod-like formed bodies, can be generated discontinuously or continuously with the pressure casting method. Aluminium with thixotropic properties can for example be achieved by melting aluminium or aluminium alloys and rapid cooling under constant agitation until setting.

The materials and formed bodies according to the invention have good thermal conductivity and electrical conductivity. The temperature behaviour of the formed bodies of the materials according to the invention is excellent. The thermal expansion is low. The creep improves. By the addition of CNT to metals such as aluminium, a substantial refinement of grain structure to for example 0.6 to 0.7 μm can be observed. The addition of CNT to the metals can influence or prevent re-crystallisation. Crack propagation can be reduced or prevented by the CNT in the metal.

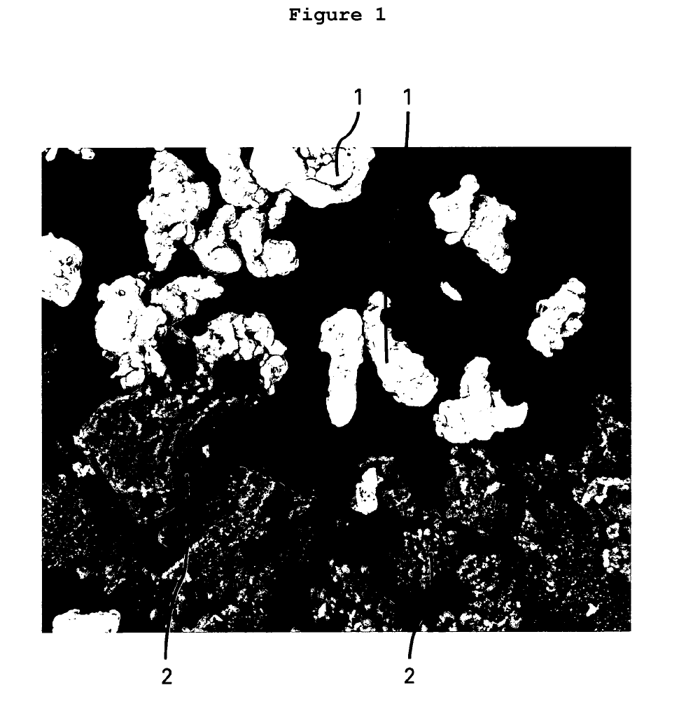

FIGS. 1 to 5 show the starting products and finished materials viewed through a microscope with great magnification.

FIG. 1 shows a mixture of aluminium particles and CNT agglomerates in magnification. The bright aluminium particles are designated (1), the dark CNT agglomerates are designated (2).

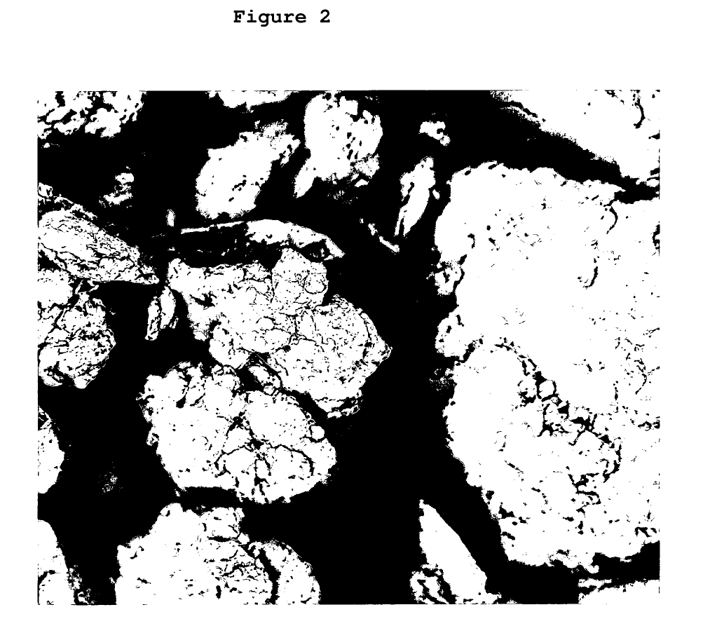

FIG. 2 shows in enlargement the material according to the invention in powder or particle form after mechanical alloying. No free CNT are visible. All CNT are absorbed into the aluminium particles which have been repeatedly deformed, broken and welded.

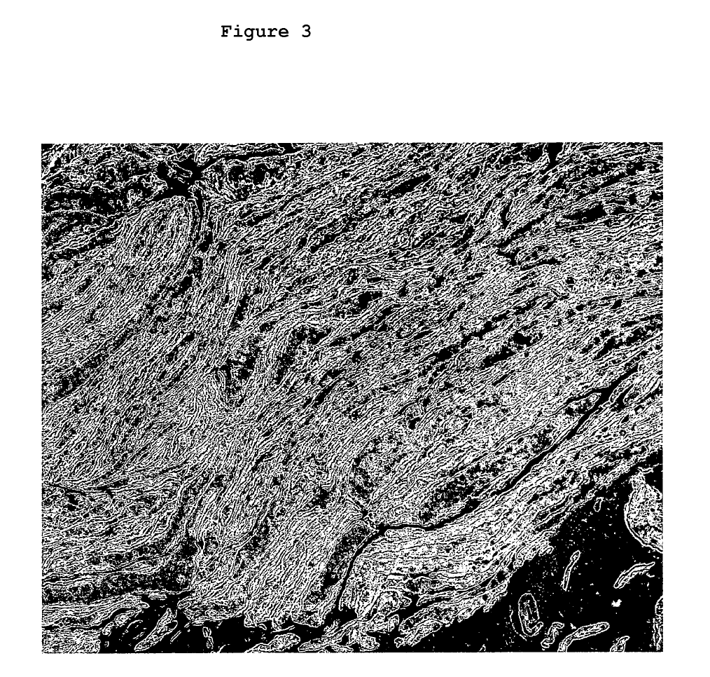

FIG. 3 shows a section through a material. Within a particle of the material a layer structure or layers can be seen. These are the layers of alternately aluminium, shaded grey in the picture, and light/dark linear inclusions of CNT.

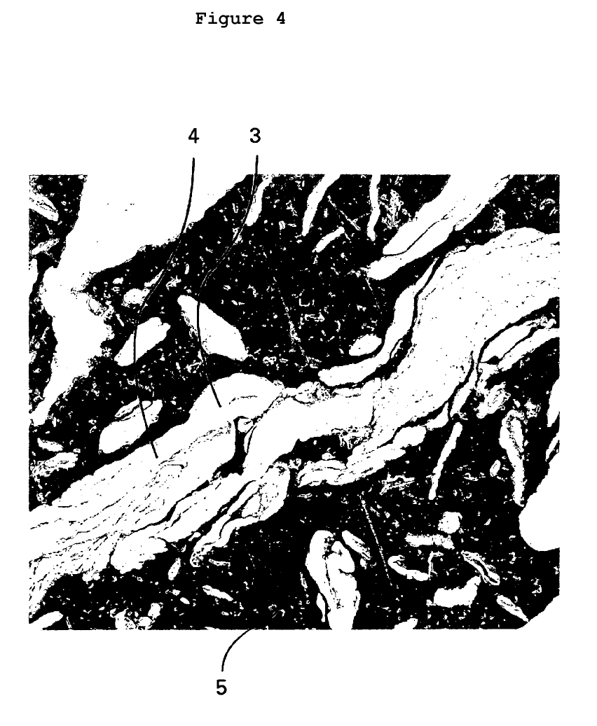

FIG. 4 shows the section through a material. Within a particle of the material a layer structure or layers can be seen. These are the layers of alternately aluminium metal (3) as a bright structure and CNT (4) as a dark linear inclusion in the aluminium. In comparison with the material in FIG. 3, the material in FIG. 4 has lower proportions of CNT which are separated by thicker layers of aluminium. The grey areas (5) which surround the particles form the resin in which the material is embedded in microscopic absorption.

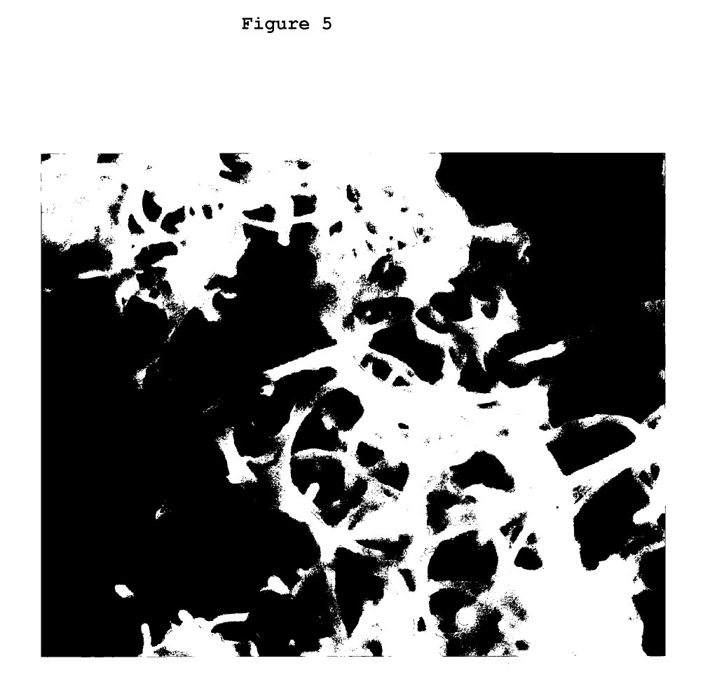

FIG. 5 shows a sponge structure of CNT such as for example can be used for production of the present materials. Such a sponge structure can also be used e.g. in the pressure casting method.

### EXAMPLES

By mechanical alloying of a powder of pure aluminium and CNT by high energy grinding in a ball mill, where a ball speed of over 11 m/s is achieved, different materials are produced by different milling durations. The materials are processed further in a powder extrusion method and a series of rod-like specimen bodies is produced. The specimen bodies are subjected to the tests listed in the table. The temperatures given in the table indicate the processing temperature during the extrusion method. The specimen bodies contain 6 w. % CNT. The time figures of 30, 60 and 120 minutes indicate the milling duration of the mechanical alloying to produce the materials. Example 1 is a comparative test of pure aluminium without CNT.

| | Tensile Strength | Brinell | Modulus of |
|---|---|---|---|
| Example No: | in N/mm² | Hardness | Elasticity KN/mm² |
| Literature, pure Al (bulk) | 70-100 | 35.9 | 70 |
| Ex. 1: pure Al, 630° C. | 138-142 | 40.1 | 71-81 |
| Ex. 2: 30 min, 630° C. | 222-231 | 66.4 | 98-101 |
| Ex. 3: 60 min, 645° C. | 236-241 | 71.1 | 71-78 |
| Ex. 4: 120 min, 645° C. | 427-471 | 160.2 | 114-125 |

It is evident from the table that the tensile strength and hardness have each increased by around 400%. The values can be controlled by the content of CNT in the material and the milling process such as the milling duration to produce the material. The modulus of elasticity can be increased by 80%. The modulus of elasticity can be influenced by the milling duration during mechanical alloying in production of the material and by the processing temperature in the extrusion method.

1. Material containing carbon nano tubes (CNT), characterised in that in the material comprises at least one of a metal and a plastic, and is laminated in layers alternating with layers of CNT.

2. Material according to claim 1, characterised in that the material is present in the form of particles.

3. Material according to claim 2, characterised in that a particle size of the material is from 0.5 μm to 2000 μm.

4. Material according to claim 1, characterised in that individual layers of metal or plastic have a thickness of 10 nm to 500,000 nm.

5. Material according to claim 1, characterised in that a thickness of the individual layers of CNT is from 10 nm to 100,000 nm.

6. Material according to claim 2, characterised in that within the particles of material, at least one metal or plastic is laminated in layers alternating with layers of CNT in evenly arranged layer thickness.

7. Material according to claim 2, characterised in that within the particles of material, at least one metal or plastic is laminated in layers alternating with layers of CNT, wherein each particle contains areas of higher concentration of CNT layers and lower concentration of metal or plastic layers.

8. Material according to claim 2, characterised in that through the particles of material, several CNT layers can touch in part areas and form uninterrupted CNT penetrations through the particles.

9. Material according to claim 1, characterised in that the material comprises at least one metal selected from a group consisting of: ferrous metals from the series iron, cobalt and nickel, their alloys including steels, other ferrous metals and their alloy, aluminium, magnesium, and titanium and their alloys, metals from the series vanadium, chromium, manganese, copper, zinc, tin, tantalum or tungsten and their alloys including alloys from the series brass and bronze, other non-ferrous metals and their alloys, metals from the series rhodium, palladium, platinum, gold and silver, pure or mixed together, and other precious metals.

10. Material according to 1, characterised in that the material comprises at least one polymer selected from a group consisting of: thermoplastic, elastic and duroplastic polymers, including polyolefins, cyclo-olefin copolymers, polyamide, polyester, polyacrylonitrile, polystyrene, polycarbonate, polyvinylchloride, polyvinylacetate, styrene-butadiene copolymers, acrylonitrile-butadiene copolymers, polyurethane, polyacrylate and copolymers, alkyd resins, epoxide, phenol-formaldehyde resin, and urea-formaldehyde resin, pure or mixed together.

11. Material according to claims claim 1, characterised in that the metal comprises at least one of aluminium and aluminium alloy.

12. Material according to claim 1, characterised in that the CNT have a diameter of 0.4 nm to 50 nm and a length of 5 nm to 50,000 nm.

13. Material according to claim 1, characterised in that the CNT have two- or three-dimensional skeletal bodies made of carbon nano tubes.

14. Material according to claim 1, characterised in that the material contains quantities of CNT from 0.1 to 50 w. % in relation to the material.

15. Material according to claim 11, characterised in that the material contains 0.5 to 10 w. % CNT.

16. Method for production of a material according to claim 1, characterised in that the metal or plastic and CNT are processed in the form of granulates, particles or powder, by mechanical alloying.

17. Method for production of a material according to claim 16, characterised in that the mechanical alloying is performed by repeated deformation, breaking and welding of particles of metal or plastic and particles of CNT, by mechanical alloying in a ball mill containing a milling chamber and milling balls as milling bodies with high energy ball collisions.

18. Method for production of a material according to claim 17, characterised in that the ball mill is a milling chamber with a cylindrical cross-section and the milling balls are moved by the milling chamber rotating about its cylindrical axis and accelerated by a driven rotary body extending in the direction of the cylinder axis into the milling chamber and fitted with a multiplicity of cams.

19. Method for production of a material according to claim 17, characterised in that a speed of the milling balls is at least 11 m/s.

20. Method for production of a material according to claim 17, characterised in that a milling duration is 10 hours or less and a minimum milling duration is 5 minutes.

21. Method for production of a material according to claim 18, characterised in that the rotary body has a multiplicity of cams distributed over an entire length thereof and extends over the entire extent of the milling chamber in the cylindrical axis.

22. Method for production of a material according to claim 17, characterised in that two or more different materials are mixed or subjected to at least one additional.

23. Method for production of a material according to claim 22, characterised in that a CNT-free metal or plastic is used as the at least one material mixed or subjected to at least one additional milling.

24. Moulded body comprising the material according to claim 1, wherein the body is produced by a technique selected from a group consisting of: spray compacting, thermal spray methods, plasma spraying, extrusion methods, sintering methods, pressure-controlled infiltration methods, and pressure casting.
